(19) United States
(12) Patent Application Publication
(10) Pub. No.: US 2002/0129497 A1
(43) Pub. Date: Sep. 19, 2002

(54) Scissors with adjustable finger loop

(76) Inventors: Grant S. Lyddon, Santa Monica, CA (US); Joseph Ramos, San Pedro, CA (US)

Correspondence Address: George J. Netter, Esq., LAW OFFICES OF GEORGE J. NETTER, 260 So. Los Robles Ave., #216, Pasadena, CA, 91101, US

(21) Appl. No.: 09/809,390

(22) Filed: Mar. 16, 2001

(51) Int. Cl. B26B 13/20

(52) U.S. Cl. 30/232; 30/341

(57) ABSTRACT

A pair of the hair cutting scissors (10) includes a finger loop (20), preferably the one for the thumb, which has a finger loop part (32) that can be selectively interconnected with a fixed finger loop part (22) to vary the finger loop area.

### BACKGROUND OF THE INVENTION

1. Field of the Invention

The present invention relates generally to scissors, and more particularly to haircutting scissors having a finger loop and especially a thumb loop that is selectively adjustable to fit different sized fingers.

2. Description of Related Art

Scissors are a well known hand operated work tool used by barbers and hairdressers, among others. Specifically, in operation fingers of one hand are inserted through loops of two blades rotatably mounted together and the blades are alternately closed on one another for cutting and then separated to repeat the cycle. The force to close and open the scissor blades is applied essentially by the fingers of one hand and particularly exerted by limited area pressure points on the finger parts received within the finger loops. The thumb, in particular, receives considerable pressure.

Scissor use over relatively long periods of time, as in a trade or profession such as haircutting, for example, causes the muscles of the hands to become very tired and sore. In fact, so-called repetitive motion disabilities can result and become chronic, or even permanent. This undesirable condition is exacerbated even more if the finger loops are not appropriately sized for the individual fingers of the operator. If the finger loops are too small for an individual operator, the scissor loops will press into the sides of the finger (especially the thumb) making it sore. However, if the loops are too large not only are the scissors awkward to use but the fingers may slide around in the loops causing pain and discomfort from that cause.

In an attempt to alleviate this problem, there are available inserts which can be applied to oversize scissor finger loops which are made of a nonmetallic material (e.g., plastic) thereby reducing direct pressure soreness, and, of course, reducing the finger loop area from one fixed size to another fixed size. If other individuals are to use the so-modified scissors or the original scissors owner experiences a finger size change, a new and differently dimensioned insert would have to be obtained. Moreover, where a loop insert is made of plastic or rubber size, size change occasioned by wear must be expected.

### SUMMARY OF THE INVENTION

In the practice of the present invention there is provided a pair of rotatably joined scissor blades having a respective pair of finger loops in which the thumb loop is constructed of two interfitted curved parts, namely, a first removable part having an end portion provided with a plurality of openings that can be adjustably locked onto a retaining end portion of the second loop part which is unitary with the scissors blade. When the loop parts are appropriately interfitted, a threaded pin fixedly secures the first loop part to the second loop in any given loop opening size.

### BRIEF DESCRIPTION OF THE DRAWING

The various objects and advantages of the present invention will become more readily apparent upon reading the following description and upon reference to the attached drawings, in which:

FIG. 1 is a perspective view of a pair of scissors constructed in accordance with the present invention;

FIG. 2 is an elevational view of the scissors of FIG. 1 invention;

FIG. 3 is an enlarged, partially fragmentary view of the adjustable finger loop part; and

FIG. 4 is an elevational view of the invention shown held in the hand of a user.

### DESCRIPTION OF A PREFERRED EMBODIMENT

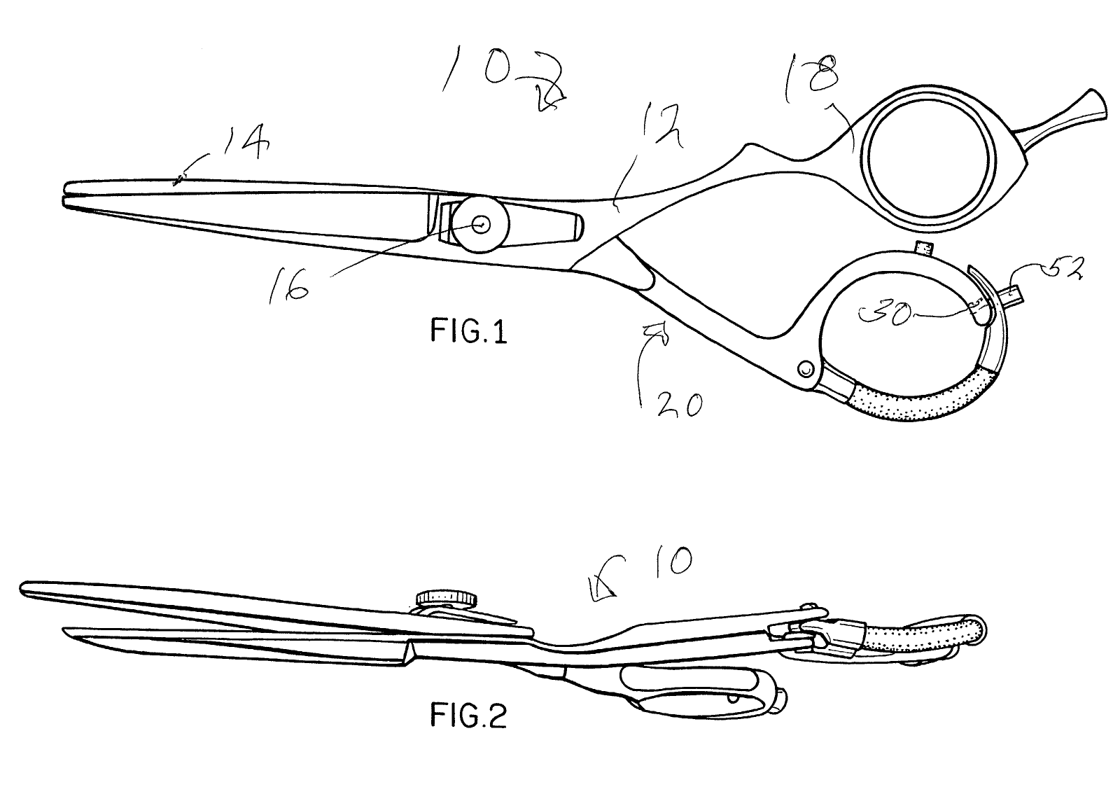

Turning now to the drawings and particularly FIG. 1, a first embodiment of scissors of the present invention is enumerated generally as 10. In its major components, the scissors are seen to include first and second scissor blades 12 and 14 rotatably secured to one another by a pivot member 16, and first and second finger loop means 18 and 20 for the respective scissor blades. The components 12, 14 and 16 may be of conventional construction whereas the subject invention relates essentially to the construction of the finger loop means 20 and the adjustable thumb loop size provided thereby.

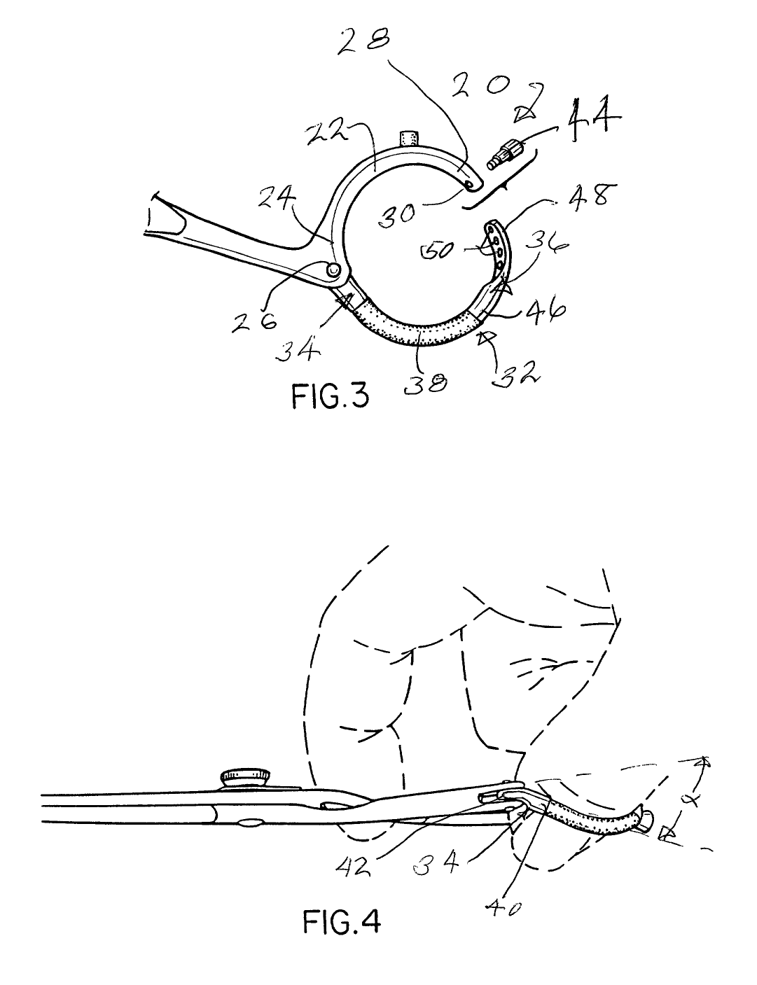

As shown best in FIG. 3, the overall geometry of finger loop 20 is slightly oval, although the shape can vary somewhat (e.g., circular). A fixed finger loop part 22 is integral with scissor blade 14 and has a somewhat oval half-circle shape, a scissor blade end 24 of which includes a transverse threaded opening 26 and the other or free end 28 of which incudes a threaded opening 30 for a use to be described later.

A second and removable finger loop part 32 is also generally semi-circular or slightly oval and is so dimensioned that its ends can generally coincide with the ends of the fixed loop part 22 to form a complete closed finger loop (FIG. 1). The finger loop part 32 includes a composite of three parts, namely, a first end connector 34, a second end connector 36 and a central flexible portion 38 interconnected with both the first and second end connectors.

More particularly, the first end connector 34 of the removable loop part is constructed of metal and has a hollow end 40 and an integral tab 42 (FIG. 2). The tab incudes transverse opening (not shown) for receiving a large-headed threaded pin 44 therethrough and threaded into opening 26 to secure the fixed and removable loop parts together.

As can be seen best in FIG. 4, the tab 42 is canted with respect to the hollow end 40 at an angle α to aid in reducing pressure on the thumb of the user.

The central portion 38 of the removable finger loop part 32 consists of a length of cylindrical rubber or flexible plastic material, one end portion of which is secured within the hollow end 40 of first end connector 34 and the other end portion of which is secured to the second end connector 36, as will be described.

The second end connector 36 includes a hollow end portion 46 within which the outer end of the flexible center portion 38 is secured. Unitary with end portion 46 is connector strip 48 including a plurality of spaced apart openings 50 and which strip has a curvature enabling fitting receipt onto and against the outer surface of 22. A threaded member 52 on being received within one of the openings 50 and threaded within opening 30 serves to provide a corresponding opening size for the thumb loop 20.

To change the thumb loop opening size, the member 52 is removed and then inserted into another more appropriate opening 50 and threaded again into opening 30.

By practice of the present invention, a pair of scissors can have the opening in the thumb loop customized to comfortably fit a wide range of different finger (thumb) sizes. Moreover, any desired change in loop size can be quickly and easily achieved.

Although the invention has been described in connection with a preferred embodiment, it is contemplated that one skilled in art may make modifications that come within spirit of the invention as described and within the ambit of the appended claims. For example, it could be advantageous to modify the loop 18 in the same manner as loop 20, only directed to accommodate different sizes in a user's index finger.

What is claimed is:

1. An adjustable finger loop for scissors having first and second blades, comprising;
a selectively removable finger loop part having a first end connector including first and second openings, a second end connector provided with a plurality of spaced apart adjustment openings and a hollow end portion, and flexible means having a first end portion secured with the removable finger loop part first opening and a second end portion secured within the hollow end portion of the second end connector;
another finger loop part fixed to a scissors blade with first and second end portions each including an opening therein; and
means for securing the removable loop part and other loop part together to form a full finger loop

2. An adjustable finger loop as in claim 1, in which the securing means includes first and second threaded pin means extended through respective openings in the removable finger loop part end connectors and openings in the other finger loop end portions.

3. An adjustable finger loop as in claim 1, in which the removable finger loop part second end connector hollow end portion receives a part of the flexible means secured therein, and the adjustment openings are formed in a curved connector strip of such curvature as to generally conform to the fixed other loop part.

4. An adjustable finger loop as in claim 1, in which the flexible means includes a generally cylindrical extent made of rubber.

5. An adjustable finger loop as in claim 1, in which the first end connector is a unitary means constructed of metal including a tab and a hollow opening within which the flexible means is secured, said tab being canted at a predetermined angle α to the hollow opening.

6. An adjustable finger loop as in claim 1, in which on assembly of the loop parts concavely curved portions face each other forming a closed continuously curved finger loop of selectively adjustable dimensions.
